(19) United States
(12) Patent Application Publication
(10) Pub. No.: US 2023/0097349 A1
(43) Pub. Date: Mar. 30, 2023

(54) TERMINAL INSERTION METHOD AND TERMINAL INSERTION DEVICE

(71) Applicant: YAZAKI CORPORATION, Tokyo (JP)

(72) Inventors: Hajime NAGANO, Makinohara-shi (JP); Kazuhiko TAKADA, Makinohara-shi (JP)

(73) Assignee: YAZAKI CORPORATION, Tokyo (JP)

(21) Appl. No.: 17/950,356

(22) Filed: Sep. 22, 2022

(30) Foreign Application Priority Data
Sep. 27, 2021 (JP) 2021-157109

(51) Int. Cl. H01R 43/20; G06T 7/00

(52) U.S. Cl. CPC H01R 43/20; G06T 7/0004; G06T 2207/30164

(57) ABSTRACT

A terminal insertion method includes a reference position setting process of capturing an image of a subject for reference position measurement gripped by the chuck and setting a reference position based on a captured image, a posture correction process of capturing an image of the terminal gripped by the chuck, obtaining an inclination of the terminal for a specific part of the terminal in the captured image, and correcting a posture of the terminal, a terminal position calculation process of capturing again the image of the terminal whose posture is corrected and calculating a position of the terminal based on the captured image, and an insertion process of correcting the position of the terminal using a difference between a calculated measurement position of the terminal and the reference position as a correction value and inserting the terminal into the cavity of the housing.

### CROSS REFERENCE TO RELATED APPLICATIONS

This application is based on and claims priority from Japanese patent application No. 2021-157109 filed on Sep. 27, 2021, the entire contents of which are incorporated herein by reference.

### TECHNICAL FIELD

The present invention relates to a terminal insertion method and a terminal insertion device.

### BACKGROUND ART

Patent Literature 1 discloses a terminal insertion device for inserting a terminal provided at an end portion of a cable into a plug housing. It is disclosed that in this device, a laser is applied to the terminal from two directions, a shielded length is measured, and an inclination of the terminal is obtained.

### CITATION LIST

### Patent Literature

Patent Literature 1: U.S. Pat. No. 6,842,975 specification

### SUMMARY OF INVENTION

In Patent Literature 1, since the inclination of the terminal is obtained by rotating the terminal to repeat measurement until the shielded length is minimum, a measurement error may occur when the terminal is rotated clockwise and counterclockwise.

In addition, since a posture of the terminal is detected by obtaining a width of the terminal, it is necessary to largely rotate the terminal regardless of whether the terminal is inclined to the right or inclined to the left, which takes time for the measurement.

The invention has been made in view of the above-described circumstances, and an object of the invention is to provide a terminal insertion method and a terminal insertion device capable of rapidly measuring a posture and a position of a terminal and smoothly inserting the terminal into a cavity of a housing.

According to an embodiment, a terminal insertion method of gripping a terminal by a chuck and inserting the terminal into a cavity of a housing includes,

a reference position setting process of capturing an image of a subject for reference position measurement gripped by the chuck and setting a reference position based on a captured image;

a posture correction process of capturing an image of the terminal gripped by the chuck, obtaining an inclination of the terminal for a specific part of the terminal in the captured image, and correcting a posture of the terminal based on the obtained inclination;

a terminal position calculation process of capturing again the image of the terminal whose posture is corrected and calculating a position of the terminal based on the captured image; and

an insertion process of correcting the position of the terminal using a difference between a calculated measurement position of the terminal and the reference position as a correction value and inserting the terminal into the cavity of the housing.

According to an embodiment, a terminal insertion device includes,

a chuck configured to grip a terminal;

an image capture unit configured to capture an image of the terminal gripped by the chuck;

a drive mechanism configured to move the chuck; and

a control unit configured to control the drive mechanism to insert the terminal gripped by the chuck into a cavity of a housing,

in which the control unit includes:

a reference position setting unit configured to cause the image capture unit to capture an image of a subject for reference position measurement gripped by the chuck and set a reference position based on a captured image thereof;

a posture correction unit configured to cause the image capture unit to capture an image of the terminal gripped by the chuck, obtain an inclination of the terminal for a specific part of the terminal in the captured image, and correct a posture of the terminal based on the obtained inclination;

a terminal position calculation unit configured to cause the image capture unit to capture again the image of the terminal whose posture is corrected, and calculate a position of the terminal based on the captured image; and

a terminal insertion unit configured to correct the position of the terminal using a difference between a calculated measurement position of the terminal and the reference position as a correction value and insert the terminal into the cavity of the housing by the drive mechanism.

### BRIEF DESCRIPTION OF DRAWINGS

FIG. 1 is a schematic perspective view of a terminal insertion device according to the present embodiment.

FIG. 2 is a front view of a terminal showing a shape of the terminal.

FIG. 3 is a schematic block diagram showing functions of the terminal insertion device.

FIG. 4 is a flowchart showing a flow of a process in an insertion operation of the terminal.

FIG. 5 is a schematic diagram showing a captured image of a subject for reference position measurement.

FIG. 6 is a schematic diagram showing a reference image of the terminal.

FIG. 7 is a schematic diagram showing a captured image of the terminal.

FIG. 8 is a schematic diagram showing a captured image of a terminal in a normal posture.

### DESCRIPTION OF EMBODIMENTS

An embodiment according to the invention will be described below with reference to the drawings.

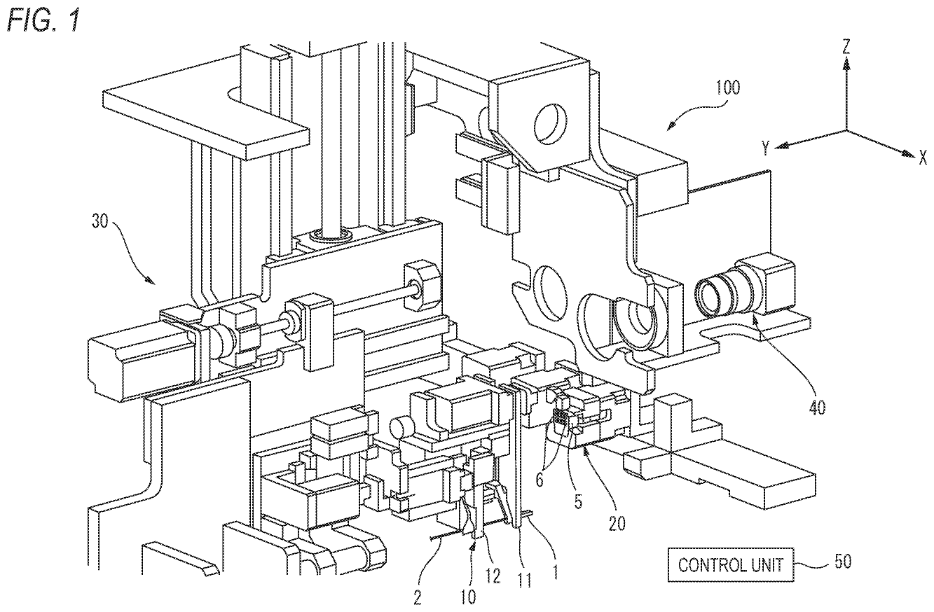

FIG. 1 is a schematic perspective view of a terminal insertion device according to the present embodiment.

As shown in FIG. 1, a terminal insertion device 100 according to the present embodiment includes a chuck 10 that grips a terminal 1, and a housing holder 20 that holds a housing 5. This terminal insertion device 100 is a device that inserts the terminal 1 gripped by the chuck 10 into a cavity 6 of the housing 5 held by the housing holder 20. The terminal 1 is formed of a conductive metal material and is connected to an end portion of an electric wire 2. The terminal 1 is inserted into and accommodated in the cavity 6 of the housing 5.

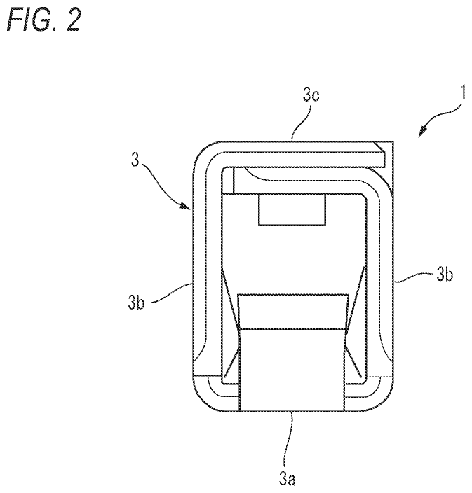

FIG. 2 is a front view of the terminal showing a shape of the terminal.

As shown in FIG. 2, the terminal 1 includes an electrical connection portion 3 formed in a rectangular tube shape on a tip end side opposite to a connection side with the electric wire 2. The electrical connection portion 3 includes a bottom plate portion 3a, a pair of side plate portions 3b, and an upper plate portion 3c. A tab (not shown) of a mating terminal is inserted into the terminal 1 from the tip end side with respect to the electrical connection portion 3. Accordingly, the terminal 1 is electrically connected to the mating terminal.

As shown in FIG. 1, the chuck 10 includes a terminal chuck portion 11 and an electric wire chuck portion 12. In the chuck 10, the terminal chuck portion 11 grips the terminal 1, and the electric wire chuck portion 12 grips the electric wire 2. The chuck 10 rotatably drives the terminal 1 about an axis of the terminal 1. The housing holder 20 holds the housing 5. The housing 5 is molded from a synthetic resin and includes a plurality of cavities 6 for accommodating the terminals 1. The housing holder 20 grips the housing 5 such that opening portions on a rear portion side of the plurality of cavities 6 are directed toward a chuck 10 side.

The terminal insertion device 100 further includes a drive mechanism 30, a camera 40, and a control unit 50.

The drive mechanism 30 moves the chuck 10 in a horizontal plane (an X direction and a Y direction) and moves the chuck 10 in a vertical direction (a Z direction). The drive mechanism 30 moves the chuck 10 to insert the terminal 1 gripped by the chuck 10 into the cavity 6 of the housing 5 held by the housing holder 20.

The camera 40 is, for example, a CCD camera. This camera 40 is disposed such that a capturing direction thereof is directed toward the chuck 10 side. In this camera 40, the chuck 10 moved by the drive mechanism 30 is disposed at a capturing direction of the camera 40. Accordingly, the camera 40 captures an image of the terminal 1 gripped by the chuck 10.

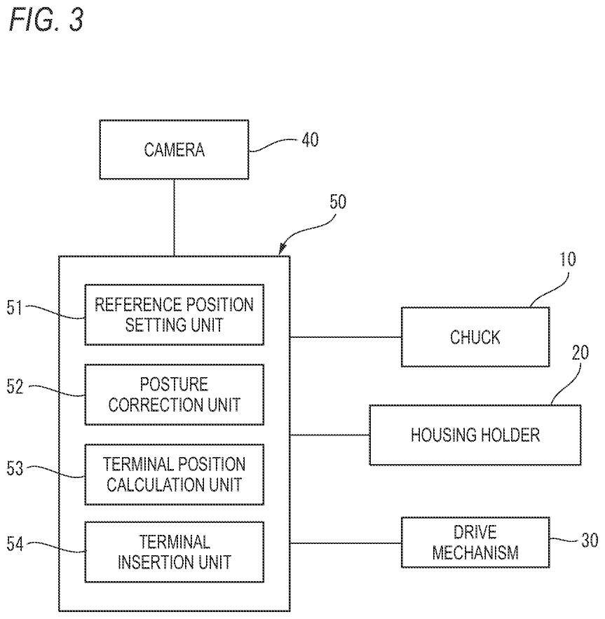

FIG. 3 is a schematic block diagram showing functions of the terminal insertion device.

As shown in FIG. 3, the control unit 50 is connected to the chuck 10, the housing holder 20, and the drive mechanism 30, and controls drive units of the chuck 10, the housing holder 20, and the drive mechanism 30. Further, the camera 40 is connected to the control unit 50, and image data is transmitted from the camera 40.

This control unit 50 includes a reference position setting unit 51, a posture correction unit 52, a terminal position calculation unit 53, and a terminal insertion unit 54.

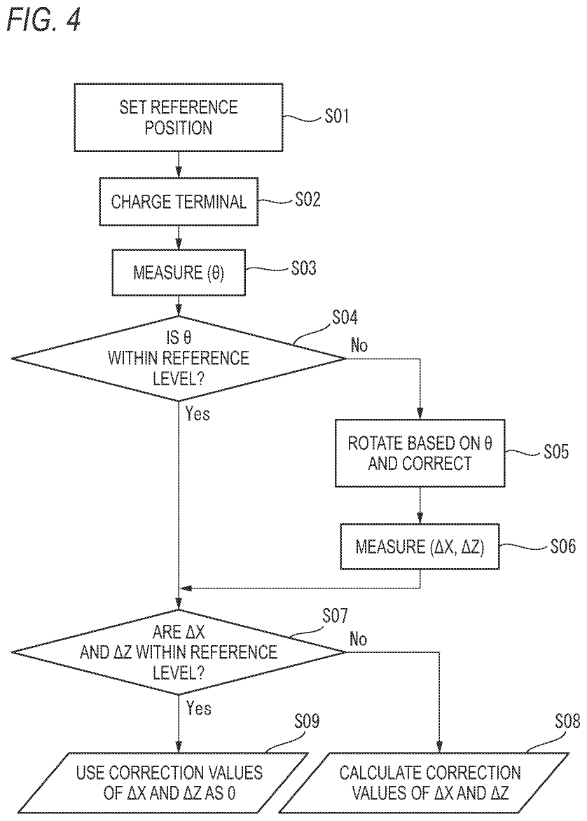

Next, an insertion operation of the terminal 1 by the control unit 50 in the terminal insertion device 100 will be described with reference to a flowchart shown in FIG. 4.

First, the chuck 10 grips a subject for reference position measurement A. This subject for reference position measurement A is implemented by, for example, a round bar pin, and this subject for reference position measurement A is gripped by the terminal chuck portion 11 of the chuck 10.

In this state, the reference position setting unit 51 of the control unit 50 performs a reference position setting process (S01). Specifically, the drive mechanism 30 is driven to dispose the chuck 10 griping the subject for reference position measurement A at the capturing position of the camera 40. Then, the subject for reference position measurement A gripped by the chuck 10 is captured by the camera 40, and a reference position is set based on the captured image.

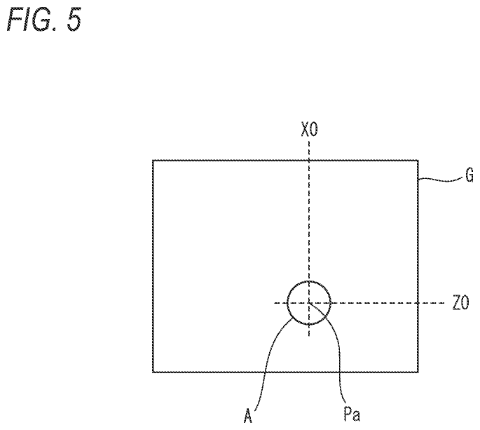

Here, FIG. 5 is a schematic diagram showing a captured image G of the subject for reference position measurement A, and the reference position setting unit 51 sets coordinates (X0, Z0) of a center of the subject for reference position measurement A in the captured image G to a reference position Pa.

Next, when the chuck 10 grips the terminal 1 inserted into the cavity 6 of the housing 5, the posture correction unit 52 of the control unit 50 performs a posture correction process (S02 to S04).

Specifically, when the terminal 1 is gripped by the chuck 10 (S02), the drive mechanism 30 is driven to dispose the chuck 10 at the capturing position of the camera 40. Then, the terminal 1 gripped by the chuck 10 is captured by the camera 40, and an inclination θ of the terminal 1 is obtained for a specific part of the terminal in the captured image G (S03). At this time, the posture correction unit 52 obtains the inclination θ of the terminal 1 using a reference image Gb.

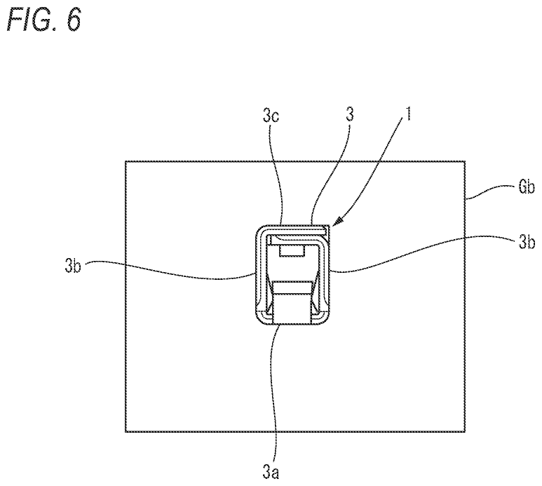

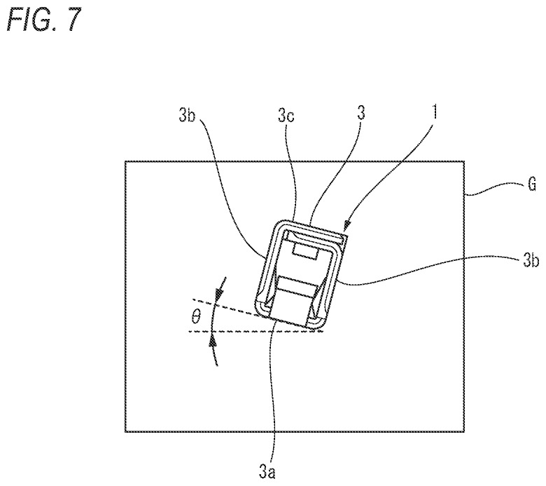

FIG. 6 is a schematic diagram showing the reference image Gb of the terminal 1. FIG. 7 is a schematic diagram showing the captured image G of the terminal 1. In the reference image Gb, for example, the terminal 1 gripped by the chuck 10 in a normal posture is captured in advance, and the captured image is registered as the reference image Gb.

The posture correction unit 52 compares the specific part of the terminal 1 in the captured image G that is captured and a specific part of the terminal 1 in the reference image Gb. The specific part of the terminal 1 is a part serving as a feature of the terminal 1, and in this example, the bottom plate portion 3a forming the electrical connection portion 3 of the terminal 1 is used as the specific part. Specifically, the bottom plate portion 3a of the electrical connection portion 3 of the terminal 1 in the reference image Gb of FIG. 6 is compared with the bottom plate portion 3a of the electrical connection portion 3 of the terminal 1 in the captured image G of FIG. 7. Then, the inclination θ of the terminal 1 in the captured image G is obtained by comparing the specific parts.

When the obtained inclination θ of the terminal 1 exceeds a reference level set in advance (No in S04), the posture correction unit 52 corrects the posture of the terminal 1 to the normal posture without the inclination θ (S05). Specifically, the posture correction unit 52 rotates the terminal 1 about an axis by driving the drive unit of the chuck 10 based on the obtained inclination θ of the terminal 1, and corrects the posture to the normal posture.

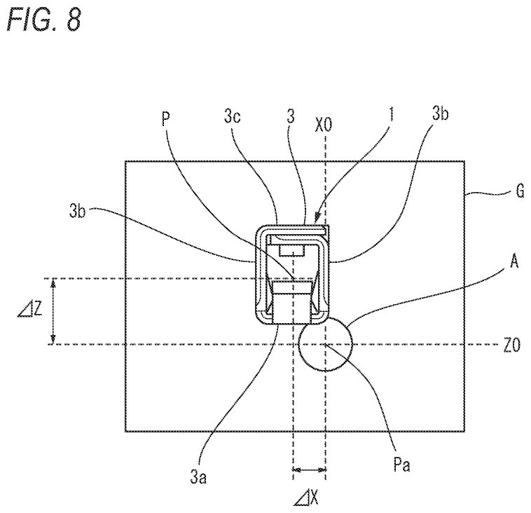

Next, the terminal position calculation unit 53 of the control unit 50 causes the camera 40 to capture again the image of the terminal 1 in the normal posture, and calculates a measurement position P in the horizontal direction (X direction) and the vertical direction (Z direction) of the center of the terminal 1 based on the captured image G (S06). FIG. 8 is a schematic diagram showing the captured image G in which the terminal 1 in the normal posture is captured again by the camera 40.

Thereafter, the terminal insertion unit 54 of the control unit 50 compares calculated coordinates of the measurement position P of the terminal 1 with the coordinates (X0, Z0) of the reference position Pa obtained from the subject for reference position measurement A, and obtains a difference (ΔX) in the horizontal direction and a difference (ΔZ) in the vertical direction. Then, when the difference (ΔX) in the horizontal direction and the difference (ΔZ) in the vertical direction exceed the reference level set in advance (No in S07), the position of the terminal 1 is corrected using these differences (ΔX, ΔZ) as correction values (S08). After the position of the terminal 1 is corrected, the drive mechanism 30 is driven to insert the terminal 1 gripped by the chuck 10 into the cavity 6 of the housing 5 held by the housing holder 20.

When the inclination θ of the terminal 1 obtained in the posture correction process is within the reference level set in advance (Yes in S04), a posture correction (S05) of the terminal 1 and a position calculation (S06) based on the captured image G that is captured again are not performed, and the captured image G used for inclination determination is used for calculation of the measurement position P.

Further, in the calculation of the measurement position P, when the difference (ΔZ) in the vertical direction and the difference (ΔX) in the horizontal direction are within the reference level set in advance (Yes in S07), the position correction of the terminal 1 is not performed using the correction value as 0 (S09), and the terminal 1 is inserted into the cavity 6 of the housing 5.

As described above, according to the terminal insertion method and the terminal insertion device according to the present embodiment, since the inclination of the terminal 1 is calculated for the specific part of the terminal 1 and the posture is corrected, a time required for the posture correction can be shortened. In addition, since the measurement of the position of the terminal 1 is performed in a state in which the posture of the terminal 1 is correct, a measurement error of the position that occurs in accordance with the shape of the terminal 1 can be prevented. Therefore, the posture and the position of the terminal 1 can be rapidly measured and corrected, and the terminal 1 can be smoothly inserted into the cavity 6 of the housing 5.

In addition, by comparing the specific part of the terminal 1 in the captured image G with the specific part of the terminal 1 in the reference image Gb registered in advance, the inclination of the terminal 1 can be easily and accurately obtained.

The present invention is not limited to the above-described embodiment, and modifications, improvements, and the like can be made as appropriate. In addition, materials, shapes, dimensions, numbers, arrangement locations, and the like of components in the above-described embodiment are optional and not limited as long as the present invention can be achieved.

According to an embodiment, a terminal insertion method of gripping a terminal (1) by a chuck (10) and inserting the terminal (1) into a cavity (6) of a housing (5) includes,

a reference position setting process of capturing an image of a subject for reference position measurement (A) gripped by the chuck (10) and setting a reference position (Pa) based on a captured image (G),

a posture correction process of capturing an image of the terminal (1) gripped by the chuck (10), obtaining an inclination (0) of the terminal (1) for a specific part of the terminal (1) in the captured image (G), and correcting a posture of the terminal (1) based on the obtained inclination (θ),

a terminal position calculation process of capturing again the image of the terminal (1) whose posture is corrected and calculating a position of the terminal (1) based on the captured image (G), and

an insertion process of correcting the position of the terminal (1) using a difference between a calculated measurement position (P) of the terminal (1) and the reference position (Pa) as a correction value and inserting the terminal (1) into the cavity (6) of the housing (5).

According to the terminal insertion method of the configuration of the above, since the posture is corrected by calculating the inclination of the terminal for the specific part of the terminal, the time required for the posture correction can be shortened. In addition, since the measurement of the position of the terminal is performed in the state in which the posture of the terminal is correct, the measurement error of the position that occurs in accordance with the shape of the terminal can be prevented. Therefore, the posture and the position of the terminal can be rapidly measured and corrected, and the terminal can be smoothly inserted into the cavity of the housing.

The terminal insertion method may further include:

capturing the image of the terminal (1) gripped by the chuck (10) in a normal posture and registering the captured image as a reference image (Gb); and

obtaining an inclination (0) of the terminal (1) by comparing a specific part of the terminal (1) in the captured image (G) with a specific part of the terminal (1) in the reference image (Gb) in the posture correction process.

According to the terminal insertion method of the configuration of the above, the inclination of the terminal can be easily and accurately obtained by comparing the specific part of the terminal in the captured image with the specific part of the terminal in the reference image registered in advance.

According to an embodiment, a terminal insertion device includes,

a chuck (10) configured to grip a terminal (1),

an image capture unit (camera 40) configured to capture an image of the terminal (1) gripped by the chuck (10),

a drive mechanism (30) configured to move the chuck (10), and

a control unit (50) configured to control the drive mechanism (30) to insert the terminal (1) gripped by the chuck (10) into a cavity (6) of a housing (5),

in which the control unit (50) includes,

a reference position setting unit (51) configured to cause the image capture unit (camera 40) to capture an image of a subject for reference position measurement (A) gripped by the chuck (10) and set a reference position (Pa) based on a captured image (G) thereof,

a posture correction unit (52) configured to cause the image capture unit (camera 40) to capture an image of the terminal (1) gripped by the chuck (10), obtain an inclination (θ) of the terminal (1) for a specific part of the terminal (1) in the captured image (G), and correct a posture of the terminal (1) based on the obtained inclination (θ),

a terminal position calculation unit (53) configured to cause the image capture unit (camera 40) to capture again the image of the terminal (1) whose posture is corrected, and calculate a position of the terminal (1) based on the captured image (G), and

a terminal insertion unit (54) configured to correct the position of the terminal (1) using a difference between a calculated measurement position (P) of the terminal (1) and the reference position (Pa) as a correction value and insert the terminal (1) into the cavity (6) of the housing (5) by the drive mechanism (30).

According to the terminal insertion device of the configuration of the above, since the posture is corrected by calculating the inclination of the terminal for the specific part of the terminal, the time required for the posture correction can be shortened. In addition, since the measurement of the position of the terminal is performed in the state in which the posture of the terminal is correct, the measurement error of the position that occurs in accordance with the shape of the terminal can be prevented. Therefore, the posture and the position of the terminal can be rapidly measured and corrected, and the terminal can be smoothly inserted into the cavity of the housing.

In the terminal insertion device,

the control unit (50) may be configured to:

cause the image capture unit (camera 40) to capture the image of the terminal (1) gripped by the chuck (10) in a normal posture, and register the captured image as a reference image (Gb), and

obtain the inclination (θ) of the terminal (1) by comparing the specific part of the terminal (1) in the captured image (G) with the specific part of the terminal (1) in the reference image (Gb) by the posture correction unit (52).

According to the terminal insertion device of the configuration of the above, the inclination of the terminal can be easily and accurately obtained by comparing the specific part of the terminal in the captured image with the specific part of the terminal in the reference image registered in advance.

According to an embodiment, a terminal insertion method and a terminal insertion device capable of rapidly measuring a posture and a position of a terminal and smoothly inserting the terminal into a cavity of a housing can be provided.

What is claimed is:

1. A terminal insertion method of gripping a terminal by a chuck and inserting the terminal into a cavity of a housing, comprising:
a reference position setting process of capturing an image of a subject for reference position measurement gripped by the chuck and setting a reference position based on a captured image;
a posture correction process of capturing an image of the terminal gripped by the chuck, obtaining an inclination of the terminal for a specific part of the terminal in the captured image, and correcting a posture of the terminal based on the obtained inclination;
a terminal position calculation process of capturing again the image of the terminal whose posture is corrected and calculating a position of the terminal based on the captured image; and
an insertion process of correcting the position of the terminal using a difference between a calculated measurement position of the terminal and the reference position as a correction value and inserting the terminal into the cavity of the housing.

2. The terminal insertion method according to claim 1, further comprising:
capturing the image of the terminal gripped by the chuck in a normal posture and registering the captured image as a reference image; and
obtaining an inclination of the terminal by comparing a specific part of the terminal in the captured image with a specific part of the terminal in the reference image in the posture correction process.

3. A terminal insertion device, comprising:
a chuck configured to grip a terminal;
an image capture unit configured to capture an image of the terminal gripped by the chuck;
a drive mechanism configured to move the chuck; and
a control unit configured to control the drive mechanism to insert the terminal gripped by the chuck into a cavity of a housing,
wherein the control unit includes:
a reference position setting unit configured to cause the image capture unit to capture an image of a subject for reference position measurement gripped by the chuck and set a reference position based on a captured image;
a posture correction unit configured to cause the image capture unit to capture an image of the terminal gripped by the chuck, obtain an inclination of the terminal for a specific part of the terminal in the captured image, and correct a posture of the terminal based on the obtained inclination;
a terminal position calculation unit configured to cause the image capture unit to capture again the image of the terminal whose posture is corrected, and calculate a position of the terminal based on the captured image; and
a terminal insertion unit configured to correct the position of the terminal using a difference between a calculated measurement position of the terminal and the reference position as a correction value and insert the terminal into the cavity of the housing by the drive mechanism.

4. The terminal insertion device according to claim 3,
wherein the control unit is configured to:
cause the image capture unit to capture the image of the terminal gripped by the chuck in a normal posture, and register the captured image as a reference image, and
obtain the inclination of the terminal by comparing the specific part of the terminal in the captured image with a specific part of the terminal in the reference image by the posture correction unit.
